(19) United States
(12) Patent Application Publication
(10) Pub. No.: US 2013/0049350 A1
(43) Pub. Date: Feb. 28, 2013

(54) METHOD FOR PROVIDING A WATERMARKING WIRE MESH, WATERMARKING WIRE MESH, APPARATUS FOR OBTAINING IT AND ANTI-COUNTERFEITING DOCUMENT

(71) Applicant: Pasquale Pallota, Fabriano (IT)

(72) Inventor: Pasquale Pallota, Fabriano (IT)

(73) Assignee: FEDRIGONI S.P.A., Verona (IT)

(21) Appl. No.: 13/696,358

(22) PCT Filed: Nov. 23, 2010
(86) PCT No.: PCT/EP2010/067998

§ 371 Date: Nov. 6, 2012

(30) Foreign Application Priority Data
May 6, 2010 (IT) VR2010A000098
Sep. 30, 2010 (IT) VR2010A000189

(51) Int. Cl. B23K 28/00; D21F 1/44; B42D 15/00

(52) U.S. Cl. 283/85; 219/121.11; 162/312

(57) ABSTRACT

A method for providing a watermarking wire mesh, particularly for producing security paper and the like, comprising in sequence the following steps:
associating stably at least one electrotype element at a preset region of a first working face of a watermarking wire mesh;
deforming plastically at least one predefined portion of the watermarking wire mesh, which comprises at least partially the at least one electrotype element.

The present invention relates to a method for providing a watermarking wire mesh, a watermarking wire mesh and an apparatus for obtaining it.

### BACKGROUND OF THE INVENTION

As is known, a problem which is currently very felt is that concerning the prevention of counterfeiting of documents such as paper money, cheques, banknotes and the like.

Various different techniques have already been developed in order to make the forgery of documents more difficult, such as, for example, the use of watermarked paper which depicts engraved symbols or figures so that they are visible only via transmitted light (i.e. only when held up to the light).

Watermarks, in particular multitone watermarks, are very widely used, and generally depict a face of a person, typically of historical importance, an architectural detail, a landscape or other types of subject.

Such a watermark is often used in combination with one or more watermarked logos which are obtained by virtue of using so-called “electrotype” watermarked elements, which normally depict numbers, characters or details of the image which is defined by the multitone watermark.

As is known, in order to make the watermark, watermarking wire meshes are used, upon which the cellulose paste which goes to form the sheet of paper is deposited.

The watermarking wire meshes are previously subjected, at preset regions, to pressing by means of a combined action of a punch and a correspondingly shaped die so as to obtain, in such preset regions, a deformation of the wire mesh that is capable of causing, in such regions, a variability of thickness of the paper which is formed on it, with the resulting creation of the watermark.

As noted above, very often a multitone watermark, i.e. a watermark that has varying thicknesses and, consequently, varying degrees of transparency, is combined with a watermarked logo obtained by means of an electrotype element.

At a practical level, such electrotype elements are constituted by flat, shaped bodies (for example shaped like numbers, letters or logos) and are made from laminates of metal material.

Such elements are designed to be “welded”, typically by means of resistance welding processes, in proximity to the regions in which, previously, the pressing was carried out but, in any case, always at a portion that is neutral, i.e. flat and not deformed, of the watermarking wire mesh.

Since the electrotype elements are substantially flat, it is not possible to weld them at a region of the wire mesh that has already been deformed as a result of the pressing process, unless those elements were previously punched in order to deform them correspondingly to the region of the wire mesh where they are to be welded.

Attempts at this have been tried in the past but, in addition to the problems owing to the difficult positioning of the punched elements, major difficulties have been encountered in correctly executing the welding of the electrotype element to the pre-pressed wire mesh.

### SUMMARY OF THE INVENTION

The aim of the present invention is to solve the above mentioned drawback, by devising a method for providing a watermarking wire mesh in which electrotype elements or the like can be arranged at deformed portions and, therefore, at regions which are intended to provide watermarked portions.

Within this aim, an object of the present invention is to provide a watermarking wire mesh that makes it possible to provide anti-counterfeiting documents, particularly for paper money or the like, which have, in the same region, “classic” watermarks, which are generally multitone, and watermarked logos which are obtained by means of electrotype devices or the like.

Another object of the present invention is to devise a watermarking wire mesh that is adapted to provide anti-counterfeiting documents that have watermarks which can be decodified by means of optical devices or by means of “tactile” reading.

Another object is to provide an apparatus for producing watermarking wire meshes which is extremely reliable in operation.

This aim, as well as these and other objects which will become better evident hereinafter, are achieved by a method for providing a watermarking wire mesh, by a watermarking wire mesh and by an apparatus for obtaining it according to what is contained in the subsequent independent claims.

### BRIEF DESCRIPTION OF THE DRAWINGS

Further characteristics and advantages of the invention will become better apparent from the following detailed description of some preferred, but not exclusive, embodiments of a method for providing a watermarking wire mesh, of a watermarking wire mesh and of an apparatus for obtaining it according to the invention, illustrated by way of non-limiting example in the accompanying drawings, wherein:

FIG. 1 is a perspective view of a portion of a watermarking wire mesh which is associated with a perimetric supporting frame;

FIG. 2 is a view which is similar to the previous figure of a portion of a watermarking wire mesh with associated electrotype elements;

FIGS. 3 to 5 are sectional views of a sequence of the steps of plastic deformation of a portion of watermarking wire mesh;

FIG. 6 is a perspective view of a watermarking wire mesh which has a deformed portion in which an electrotype element is accommodated;

FIG. 7 is a transverse sectional view of the portion of watermarking wire mesh shown in FIG. 6;

FIG. 8 is a schematic view of a portion of paper provided with a watermark, which can be obtained by means of a watermarking wire mesh according to the invention;

FIG. 9 is a top view of another embodiment of a portion of watermarking wire mesh;

FIG. 10 is an enlarged scale sectional view of the watermarking wire mesh shown in FIG. 9, taken along the line X-X of FIG. 9.

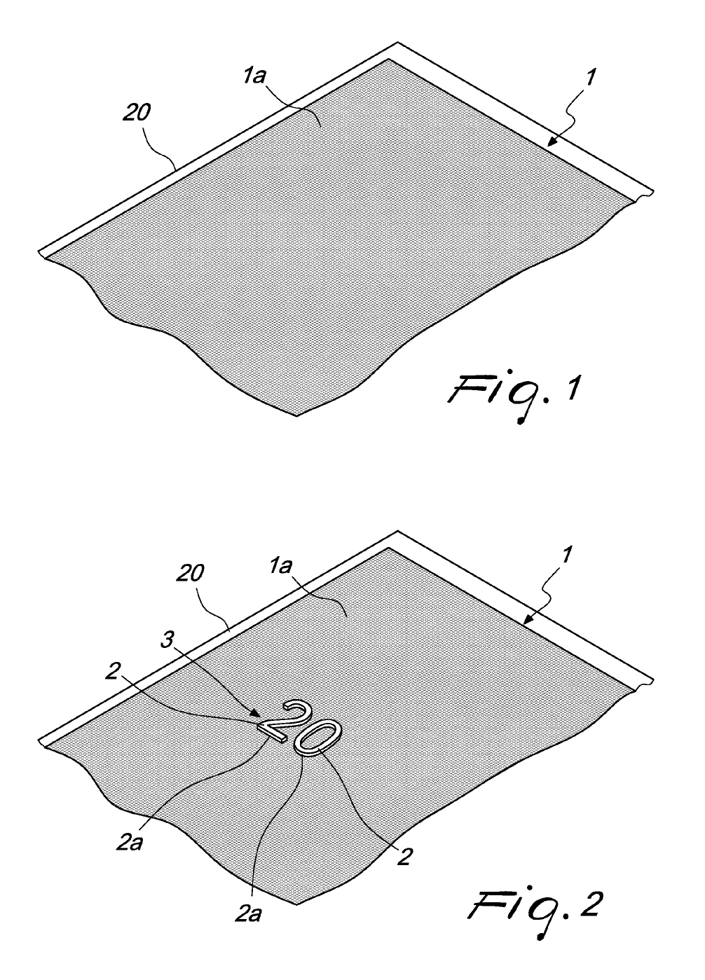

### DESCRIPTION OF THE PREFERRED EMBODIMENTS

In the exemplary embodiments that follow, individual characteristics shown in relation to specific examples may in reality be interchanged with other, different characteristics, existing in other exemplary embodiments.

With reference to the figures, the present invention relates to a method for providing a watermarking wire mesh, which is generally indicated with the reference numeral 1, particularly for the production of security paper, banknotes, paper money, bonds, bank cheques and the like.

The method according to the invention comprises, in sequence, the following steps:
associating stably at least one electrotype element 2 or the like at a preset region 3 of a first working face 1a of the watermarking wire mesh 1;
deforming plastically at least one predefined portion 4 of the watermarking wire mesh 1, which comprises at least partially the electrotype element or elements 2 or the like.

The working face 1a is the face of the watermarking wire mesh 1 which is intended, during the production of the watermarked paper, to define the surface upon which the cellulose paste is deposited.

Conveniently, the step of deforming plastically the predefined portion or portions 4 of the watermarking wire mesh 1 is performed by using at least one punch 10 and at least one respective die 11, which can be moved mutually closer and further apart on command along a movement direction 100 that is substantially perpendicular to the plane of arrangement of the watermarking wire mesh 1.

Advantageously, the step of associating the electrotype element 2 or the like with the first working face 1a of the watermarking wire mesh 1 comprises a step of welding the electrotype element 2 or the like on the first working face 1a of the watermarking wire mesh 1.

Descending into specific details, the welding step is achieved by means of a welding process chosen within the group that comprises:
laser welding;
MIG welding;
TIG welding;
resistance welding.

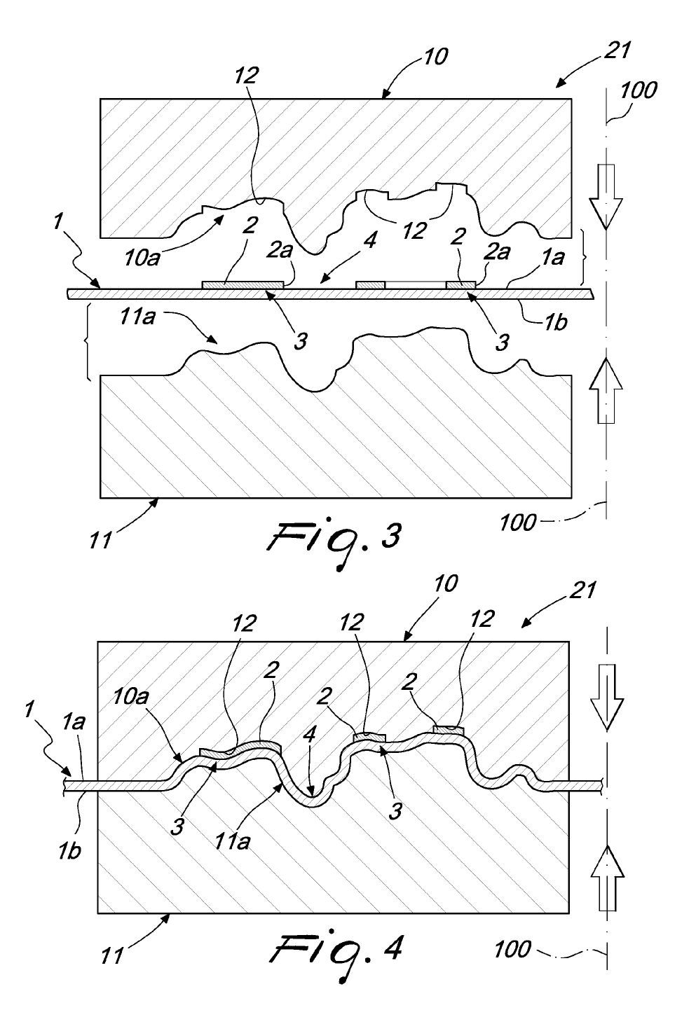

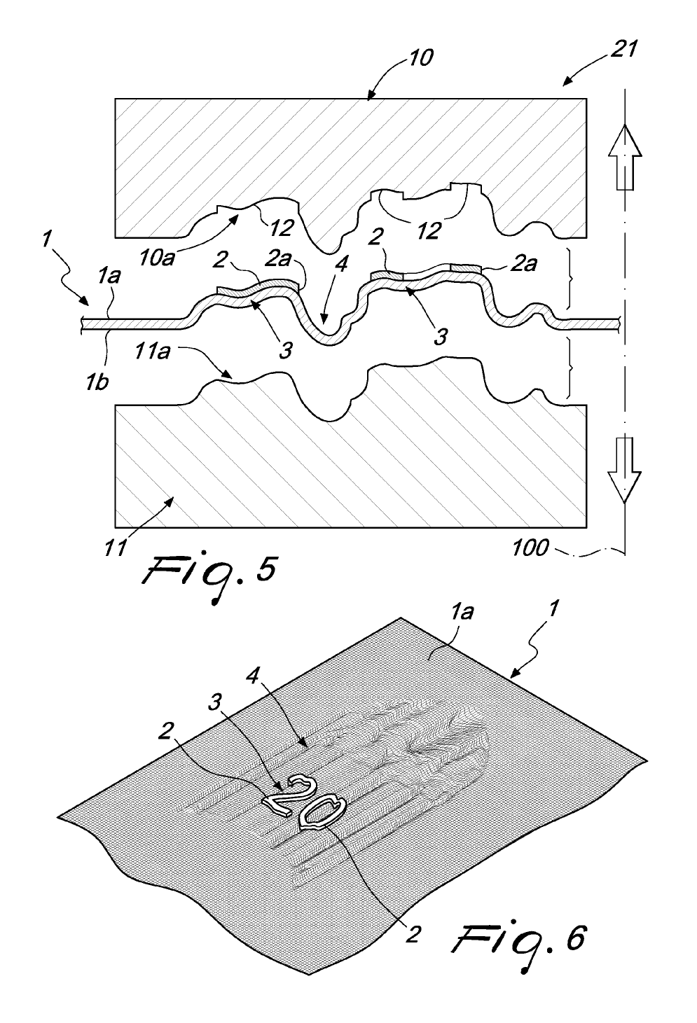

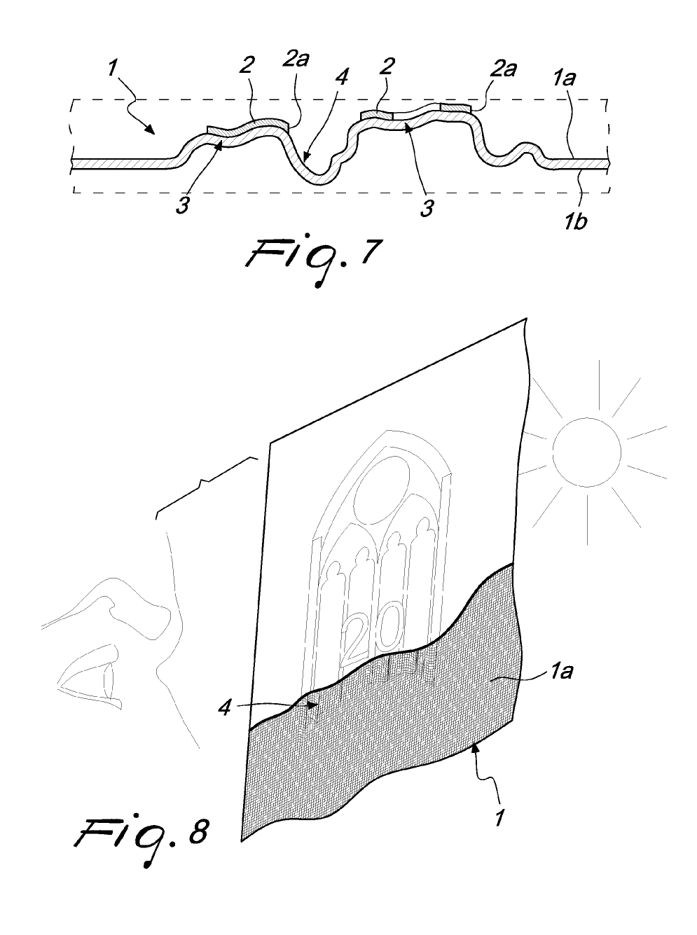

According to a preferred embodiment, the step of deforming plastically the predefined portion 4 of the watermarking wire mesh 1 comprises a step of mutual approach (see FIG. 3 and FIG. 4) between the punch 10, which is designed to engage, with a modelling surface 10a thereof, against a region to be deformed of the first working face 1a, and the die 11, which is designed to abut, with a contrast surface 11a thereof, against a respective abutment region located on a second face 1b of the watermarking wire mesh 1 that lies opposite to the first working face 1a.

Specifically, the modelling surface 10a has at least one recess 12 which is shaped complementarily with respect to a respective electrotype element 2 or the like which is associated with the first working face 1a. The or each recess 12 is arranged at a region of the modelling surface 10a that is designed to face toward a respective electrotype element 2 or the like which is applied to the first working face 1a of the watermarking wire mesh 1.

Conveniently, the method for providing a watermarking wire mesh comprises, between the step of stably associating the electrotype element or elements 2 or the like with the first working face 1a and the step of deforming plastically the predefined portion of the watermarking wire mesh 1, a step of trimming at least one portion of the lateral edge 2a of the electrotype element 2 or the like. This step is particularly important if the welding step is performed using a union material which might, in some cases, spill out from some portions of the lateral edge 2a of the electrotype element 2.

To make the electrotype elements 2 or the like, it is convenient to use metal alloys such as, for example, brass or other metals, optionally previously softened by means of an annealing process so as to render them easily malleable.

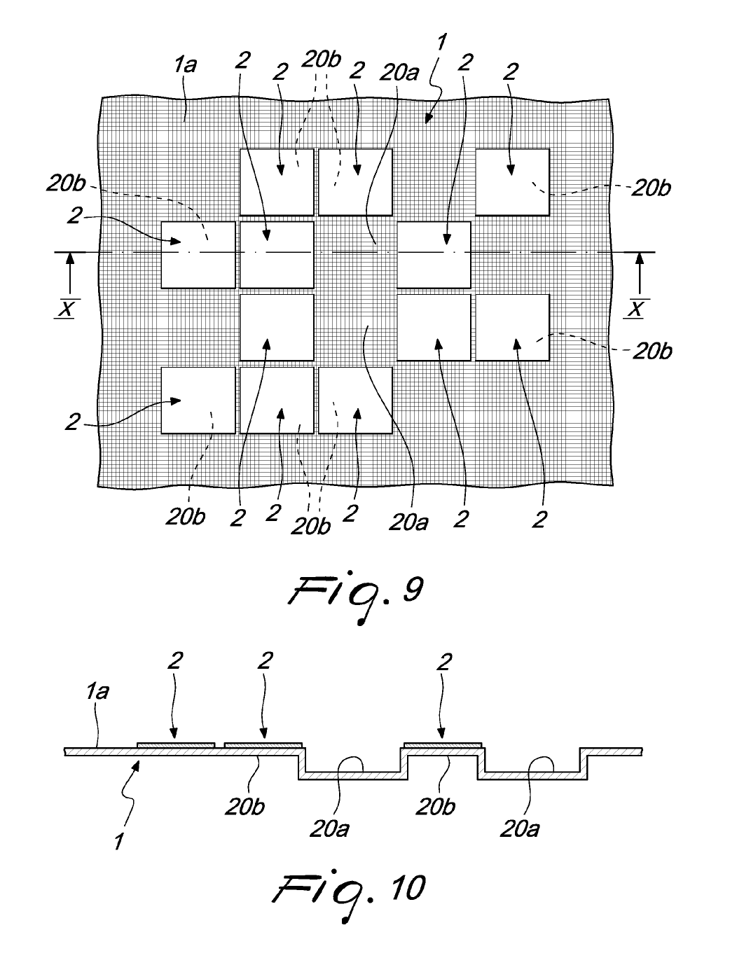

As shown in FIGS. 9 and 10, the action of the punch 10 and of the respective die 11 can conveniently be adapted to provide, on the watermarking wire mesh 1, at least one matrix-constituted area 20 which comprises a plurality of predefined regions which are adapted to make it possible to obtain, on the paper formed, a “matrix” watermark which can be decoded, advantageously, by means of using optical detection means or by means of “tactile” reading used, in particular, by blind and/or partially sighted persons.

Specifically, the matrix-constituted area 20 defines a plurality of first regular hollowed portions 20a and a plurality of second regular portions 20b which are associated with respective electrotype elements 2.

Conveniently, both the first regular hollowed portions 20a and the second regular portions 20b have the same shape, for example rectangular.

At the practical level, the watermark obtained at the matrix-constituted area 20 of the watermarking wire mesh 1 will have regular regions which are lighter (obtained at the second regular portions 20b which have the electrotype elements 2) and regular regions which are darker, obtained at the first regular hollowed portions 20a, so as to make up a matrix watermark.

By means of providing hollows of different depths or by using electrotype elements 2 which have different characteristics or thicknesses it will be possible to obtain matrices that have as many as three or more degrees of differing opacity to transmitted light.

According to another aspect, the present invention relates to an apparatus for providing a watermarking wire mesh 1.

Such apparatus comprises a perimetric supporting frame 20 for a watermarking wire mesh 1 and a grip and positioning device (not shown in the figures) that can be moved, by way of relative movement means, with respect to the watermarking wire mesh.

In this regard, it can be provided that the relative movement means act directly on the grip and positioning device (in which case the perimetric supporting frame 20 is fixed), or that such relative movement means act on the perimetric supporting frame 20, which is thus moved, on command, with respect to the grip and positioning device.

The grip and positioning device is designed, in particular, to position at least one electrotype element 2 or the like at a preset region 3 of a first working face 1a of a watermarking wire mesh 1.

The apparatus comprises, moreover, a device for welding the electrotype element or elements 2 or the like onto the or onto a respective preset region 3, and a device 21 for the plastic deformation of at least one predefined portion 4 of the watermarking wire mesh 1 which comprises, at least in part, the electrotype element or elements 2 or the like.

Advantageously, the welding device is chosen within the group that comprises:
a laser welding device;
a MIG welding device;
a TIG welding device;
a resistance welding device.

The plastic deformation device 21 comprises, in particular, at least one punch 10 and at least one respective die 11, which can be moved mutually closer and further apart on command along a movement direction 100 that is substantially perpendicular to the plane of arrangement of the watermarking wire mesh 1.

In particular, the punch 10 comprises a modelling surface 10a that is designed to engage against a region to be deformed of the first working face 1a of the watermarking wire mesh 1, while the die 11 comprises a contrast surface 11a which is designed to engage against a respective abutment region located on a second face 1b of the watermarking wire mesh 1 that lies opposite to the first working face 1a.

According to a particularly important aspect of the present invention, the modelling surface 10a has at least one recess 12 which is shaped complementarily with respect to the or to each electrotype element 2 or the like which is associated with the first working face 1a. The recess or recesses 12 are arranged at the region of the modelling surface 10a that is designed to face toward the or toward each electrotype element 2 or the like which is/are applied to the first working face 1a of the watermarking wire mesh 1.

Advantageously, the or each recess 12 has dimensions (transversal/longitudinal and, optionally, depth) that are slightly greater (by the order of 0.01 mm-0.02 mm) than the corresponding electrotype element 2 or the like so as to compensate for any small errors in positioning and welding the electrotype elements 2 on the first working face 1a.

The apparatus for providing a watermarking wire mesh 1 can provide, moreover, a device for trimming at least one portion of the lateral edge 2a of the electrotype elements 2 or the like, especially where the welding device uses union material which might, in some cases, spill out from some portions of the lateral edge 2a of the electrotype element 2.

With particular reference to the embodiment shown in FIGS. 9 and 10, the punch 10 and the respective die 11 are shaped in such a way as to provide, on the watermarking wire mesh 1, at least one matrix-constituted area 20 which comprises a plurality of predefined regions which are adapted to make it possible to obtain, on the paper formed, a “matrix” watermark which can be decoded, advantageously, by means of using optical detection means or by means of “tactile” reading used, in particular, by blind and/or partially sighted persons.

Specifically, the matrix-constituted area 20 defines a plurality of first regular hollowed portions 20a and a plurality of second regular portions 20b which are associated with respective electrotype elements 2.

Conveniently, both the first regular hollowed portions 20a and the second regular portions 20b have the same shape, for example rectangular.

At the practical level, the watermark obtained at the matrix-constituted area 20 of the watermarking wire mesh 1 will have regular regions which are lighter (obtained at the second regular portions 20b which have the electrotype elements 2) and regular regions which are darker, obtained at the first regular hollowed portions 20a, so as to make up a matrix watermark.

By means of providing hollows of different depths or by using electrotype elements 2 which have different characteristics or thicknesses it will be possible to obtain matrices that have as many as three or more degrees of differing opacity to transmitted light.

The invention provides a watermarking wire mesh 1, particularly for producing security paper and the like, which has at least one electrotype element 2 or the like, which is associated stably on a first working face 1a of the watermarking wire mesh 1 at a preset region 3. The watermarking wire mesh 1 has, moreover, a predefined portion 4 that is deformed with respect to the plane of arrangement of the watermarking wire mesh 1 that is designed to make it possible to obtain the watermark.

The deformed predefined portion comprises, in particular, at least partly the electrotype element 2 or the like.

Conveniently, the watermarking wire mesh 1, particularly for producing security paper and the like, is provided by means of a production method according to the foregoing description.

Advantageously, the watermarking wire mesh 1 has, as shown in FIGS. 9 and 10, at least one matrix-constituted area 20 which comprises a plurality of predefined regions which are adapted to make it possible to obtain, on the paper formed, a “matrix” watermark which can be decoded, advantageously, by means of using optical detection means or by means of “tactile” reading used, in particular, by blind and/or partially sighted persons.

Specifically, the matrix-constituted area 20 defines a plurality of first regular hollowed portions 20a and a plurality of second regular portions 20b which are associated with respective electrotype elements 2.

Conveniently, both the first regular hollowed portions 20a and the second regular portions 20b have the same shape, for example rectangular.

At the practical level, the watermark obtained at the matrix-constituted area 20 of the watermarking wire mesh 1 will have regular regions which are lighter (obtained at the second regular portions 20b which have the electrotype elements 2) and regular regions which are darker, obtained at the first regular hollowed portions 20a, so as to make up a matrix watermark.

By means of providing hollows of different depths or by using electrotype elements 2 which have different characteristics or thicknesses it will be possible to obtain matrices that have as many as three or more degrees of differing opacity to transmitted light.

Lastly, the present invention relates to an anti-counterfeiting document that has a “matrix” watermark which can be decoded by means of optical devices or by means of “tactile” reading used, in particular, by blind and/or partially sighted persons.

The “matrix” watermark has, visible in transmitted light, first regular regions (for example rectangular) which are lighter and at least second regular regions (for example, also rectangular) which are darker, obtained at a matrix-constituted area 20 which is defined on a watermarking wire mesh 1.

For the purposes of example, the matrix-constituted area 20 can be constituted by first regular hollowed portions 20a and by second regular portions 20b which have the same shape, for example rectangular, the latter being associated with respective electrotype elements 2.

From the foregoing description and explanation it can be seen that the invention achieves the set aim and objects.

In particular, the method and the apparatus described make it possible to obtain a watermarking wire mesh 1 in which the electrotype element 2 is associated with the watermarking wire mesh 1 in a deformed region thereof which is designed to enable the formation of a watermark, for example multitone.

Thanks to the provision of the recesses 12 which are shaped complementarily with respect to respective electrotype elements 2, it has been found that, at the same time, a correct deformation of the watermarking wire mesh 1 can be obtained in addition to the electrotype element 2 welded thereon without compromising the welding of the electrotype element 2 between the watermarking wire mesh 1.

The watermarking wire mesh 1 according to the invention lastly makes it possible to provide watermarked papers wherein the effect produced by the electrotype element 2 or the like has a variability in its luminosity (by means of observation in transmitted light) by being superimposed over the “classic” watermark.

Moreover, thanks to the method and to the apparatus described above, it is also possible to provide watermarking wire meshes 1 which make it possible to obtain “matrix” watermarks which can be decoded by means of optical detection means or instruments or by means of “tactile” reading used, in particular, by blind and/or partially sighted persons.

The invention thus conceived is susceptible of numerous modifications and variations, all of which are within the scope of the appended claims.

Moreover, all the details may be substituted by other, technically equivalent elements.

In practice the materials employed, as well as the dimensions and the contingent shapes, may be any according to requirements.

The disclosures in Italian Patent Applications No. VR2010A000098 and VR2010A000189 from which this application claims priority are incorporated herein by reference.

1-21. (canceled)

22. A method for providing a watermarking wire mesh, particularly for producing security paper and the like, comprising in sequence the following steps:
associating stably at least one electrotype element or the like at a preset region of a first working face of a watermarking wire mesh;
deforming plastically at least one predefined portion of said watermarking wire mesh, which comprises at least partially said at least one electrotype element or the like.

23. The method for providing a watermarking wire mesh according to claim 22, wherein said step of deforming plastically said at least one predefined portion of said watermarking wire mesh is performed by using at least one punch and at least one respective die, which can be moved mutually closer and further apart on command along a movement direction that is substantially perpendicular to the plane of arrangement of said watermarking wire mesh.

24. The method for providing a watermarking wire mesh according to claim 22, wherein said step of associating said at least one electrotype element or the like with said first working face comprises a step of welding said at least one electrotype element or the like on said first working face of said watermarking wire mesh.

25. The method for providing a watermarking wire mesh according to claim 24, wherein said welding step is achieved by means of a welding process chosen within the group that comprises:
laser welding;
MIG welding;
TIG welding;
resistance welding.

26. The method for providing a watermarking wire mesh according to claim 22, wherein said step of deforming plastically said at least one predefined portion of said watermarking wire mesh comprises a step of mutual approach between said punch, which is designed to engage, with a modelling surface thereof, against a region to be deformed of said first working face, and a die, which is designed to abut, with a contrast surface thereof, against a respective abutment region located on a second face of said watermarking wire mesh that lies opposite to said first working face, said modelling surface having at least one recess that is shaped complementarily with respect to said at least one electrotype element or the like associated with said first working face, said at least one recess being arranged at the region of said modelling surface that is designed to face toward said at least one electrotype element or the like applied to said first working face of said watermarking wire mesh.

27. The method for providing a watermarking wire mesh according to claim 22, further comprising between said step of stably associating said at least one electrotype element or the like with said first working face and said step of deforming plastically said at least one predefined portion of said watermarking wire mesh, a step of trimming at least one portion of the lateral edge of said at least one electrotype element or the like.

28. The method for providing a watermarking wire mesh according to claim 23, further comprising a step of providing, by means of the action of said punch and of the respective die, of at least one matrix-constituted area which comprises a plurality of predefined regions which are adapted to make it possible to obtain, on the paper formed, a “matrix” watermark which can be decoded by using optical detection means and/or by means of “tactile” reading.

29. The method for providing a watermarking wire mesh according to claim 28, wherein said at least one matrix-constituted area defines a plurality of first regular hollowed portions and a plurality of second regular portions which are associated with respective electrotype elements.

30. An apparatus for providing a watermarking wire mesh, comprising a perimetric supporting frame for a watermarking wire mesh, a grip and positioning device that can be moved, by way of relative movement means, with respect to said watermarking wire mesh, said grip and positioning device being designed to arrange at least one electrotype element at a preset region of a first working face of a watermarking wire mesh, a device being provided for welding said at least one electrotype element or the like on said preset region, said apparatus comprising a device for the plastic deformation of at least one predefined portion of said watermarking wire mesh, which comprises at least partly said at least one electrotype element or the like.

31. The apparatus for providing a watermarking wire mesh according to claim 30, wherein said welding device is chosen within the group that comprises:
a laser welding device;
a MIG welding device;
a TIG welding device;
a resistance welding device.

32. The apparatus for providing a watermarking wire mesh according to claim 30, wherein said plastic deformation device comprises at least one punch and at least one respective die, which can move mutually closer and further apart on command along a movement direction that is substantially perpendicular to the plane of arrangement of said watermarking wire mesh.

33. The apparatus for providing a watermarking wire mesh according to claim 32, wherein said punch comprises a modelling surface that is designed to engage against a region to be deformed of a first working face of said watermarking wire mesh and said respective die comprises a contrast surface that is designed to engage against a respective abutment region located on a second face of said watermarking wire mesh that lies opposite to said first working face, said modelling surface having at least one recess which is shaped complementarily with respect to said at least one electrotype element or the like associated with said first working face, said at least one recess being arranged at the region of said modelling surface that is designed to face toward said at least one electrotype element or the like applied to said first working face of said watermarking wire mesh.

34. The apparatus for providing a watermarking wire mesh according to claim 30, further comprising a device for trimming at least one portion of a lateral edge of said at least one electrotype element.

35. The apparatus for providing a watermarking wire mesh according to claim 32, wherein said punch and the respective die are shaped in such a way as to provide, on said watermarking wire mesh, at least one matrix-constituted area which comprises a plurality of predefined regions which are adapted to make it possible to obtain, on the paper formed, a “matrix” watermark which can be decoded by using optical detection means and/or by means of “tactile” reading.

36. The apparatus for providing a watermarking wire mesh according to claim 35, wherein said at least one matrix-constituted area defines a plurality of first regular hollowed portions and a plurality of second regular portions which are associated with respective electrotype elements.

37. A watermarking wire mesh, particularly for producing security paper, comprising at least one electrotype element, which is associated stably on a first working face at a preset region, said watermarking wire mesh having a predefined portion that is deformed with respect to the plane of arrangement of said watermarking wire mesh, said deformed predefined portion comprising at least partly said at least one electrotype element.

38. The watermarking wire mesh, particularly for producing security paper, according to claim 37, further comprising at least one matrix-constituted area which comprises a plurality of predefined regions which are adapted to make it possible to obtain, on the paper formed, a “matrix” watermark which can be decoded by using optical detection means and/or by means of “tactile” reading.

39. The watermarking wire mesh, particularly for producing security paper and the like, according to claim 38, wherein said matrix-constituted area defines a plurality of first regular hollowed portions and a plurality of second regular portions which are associated with respective electrotype elements.

40. A watermarking wire mesh, particularly for producing security paper, provided by means of a production method according to claim 22.

41. An anti-counterfeiting document, comprising at least one “matrix” watermark which can be decoded by means of optical devices and/or by means of “tactile” reading.

42. The anti-counterfeiting document according to claim 41, wherein said at least one “matrix” watermark has, visible in transmitted light, a plurality of first regular regions which are lighter and a plurality of at least second regular regions which are darker, and are obtained at a matrix-constituted area which is defined on a respective watermarking wire mesh.
